(19) United States
(12) Patent Application Publication
(10) Pub. No.: US 2025/0311664 A1
(43) Pub. Date: Oct. 9, 2025

(54) MULCHING APPARATUS FOR A LAWNMOWER

(71) Applicant: MulchPac LLC, Hamilton, MI (US)

(72) Inventor: Paul H. Nyboer, Hamilton, MI (US)

(21) Appl. No.: 19/089,691

(22) Filed: Mar. 25, 2025

Related U.S. Application Data
(60) Provisional application No. 63/631,520, filed on Apr. 9, 2024.

(51) Int. Cl. A01D 34/00; A01D 101/00

(52) U.S. Cl. CPC A01D 34/005; A01D 2101/00

(57) ABSTRACT

A mulching device for attachment to the mower deck of a lawnmower includes a cutting assembly separate from the lawnmower blades for mulching the grass clippings. The mulching device may include an inlet aligned with the exit port of the blade deck. The cutting assembly may compress the grass clippings before cutting them in a cutting chamber. The cutting chamber may include an adapter that increases the diameter of a secondary section of the cutting chamber to reduce some pressure and enable the use of a larger cutting blade. The device may include an air separator for separating the grass clippings from the forced air exiting the mower deck. The mulching device may also include structure to prevent the cut grass clippings from gathering and clumping near the cutting chamber. And the mulching device may include a dispersion assembly for spreading the cut grass clippings onto the ground surface.

### BACKGROUND OF THE INVENTION

The present invention relates to lawnmowers, and more particularly to a mulching device that can be attached to a lawnmower for cutting (i.e., “mulching”) the grass clippings in a manner that they can be deposited onto the ground surface.

As is generally known, lawnmowers include a mower deck that houses one or more rotating blades for cutting grass. The loose pieces of grass that have been cut by the lawnmower blades are often referred to as grass clippings.

Difficulties often arise with the disposal of grass clippings. Depositing or blowing grass clippings directly onto the ground surface can be unsightly, especially when the grass clippings are wet or particularly long, because they may clump and/or rest on top of the grass. As a result, commercial and residential lawn mowers alike generally use one of two recognized methods for disposing of grass clippings, which include: (1) collecting the grass clippings in one or more bags or other containers, or (2) re-cutting or “mulching” the grass clippings into smaller pieces that can be deposited onto the ground surface in a manner that is less visible than directly dropping the grass clippings.

Unfortunately, both of these known methods can be problematic. Collecting the grass clippings is generally done with a bagging attachment that includes a chute connected between the mower deck and one or more containers. The bagging attachment utilizes the forced air produced by the spinning mower blades, and/or an additional blower, to blow the grass clippings through the chute and into the one or more containers. Even when these bagging attachments work correctly, they are troublesome in that they require additional time for the operator to interrupt the mowing process and empty the containers, and they require a separate location for dumping the collected clippings. And in many cases, these bagging attachments fail due to the clippings clogging in the mower deck, chute or containers.

Mulching can also be problematic. Most mulching mowers re-cut the grass clippings within the mower deck by containing the grass clippings within the mower deck and using a combination of special blades and forced air to cut and re-cut the grass clippings within the mower deck. The re-cut (i.e., “mulched”) grass clippings eventually drop onto the ground surface in a smaller, and thus less unsightly, form. Unfortunately, these mulching arrangements generally only work under ideal conditions where the grass is dry and not too long. Wet grass, or particularly long grass, often clogs within the mower deck, is not re-cut as desired, and falls onto the ground surface in unwanted clumps.

### SUMMARY OF THE INVENTION

The present invention provides a mulching device for attachment to a lawnmower. The mulching device includes a cutting assembly separate from the mower blades of the lawnmower, wherein the grass clippings, leaves, thatch and other yard waste can be consistently finely cut and then dispersed onto the ground surface.

In one embodiment, the mulching device is adapted to be mounted to the lawnmower for receiving the grass clippings from the lawnmower. In one embodiment, the mulching device may be mounted directly to the blade deck of the mower, with the cutting assembly positioned adjacent to an exit port of the blade deck, the cutting assembly receiving grass clippings and including at least one cutting blade—separate from the mower blades—configured to cut the grass clippings received from the lawnmower. The device further includes an outlet that receives the mulched grass clippings from the cutting assembly, and a dispersion assembly including a dispersion fan that disperses the mulched grass clippings onto the ground surface.

The cutting assembly may be configured to at least partially compress the grass clippings prior to cutting them. This compression may provide a degree of consistency and uniformity to the re-cutting or mulching of the grass clippings. In one embodiment, the cutting assembly includes an auger with a first end and a second end, and a tube forming a cutting chamber therein. The second end of the auger may extend into the cutting chamber, such that the auger forces the grass clippings into the cutting chamber and compresses the grass clippings in the chamber. In one embodiment, the cutting chamber may include an adapter portion that increases the diameter of a secondary section of the cutting chamber to reduce some pressure and enable the use of a larger cutting blade. The cutting blade may be positioned within the adapter portion of the cutting chamber, or adjacent to the cutting chamber to cut the compressed grass clippings into smaller pieces. In a further embodiment, the helical auger twists may converge at the second end to further aid in compressing the grass clippings, and may include a decreasing outer diameter approaching the second end.

In one embodiment, the mulching device includes an air separator for separating the grass clippings from the forced air exiting the mower deck. This separation can isolate the grass clippings for purposes of cutting. The separation chamber may define an inlet, a grass clippings outlet at the bottom of the chamber and a forced air outlet spaced from the grass clippings outlet. In one embodiment, the separation chamber forms a portion of a housing, and the forced air is separated out of the housing through a wire mesh material. The housing may also include structure to prevent the cut grass clippings from gathering and clumping within the housing near the auger. This structure may include a flow control and a stationary feeder.

In another embodiment, the mulching device includes a dispersion assembly for spreading the cut grass clippings onto the ground surface. The dispersion assembly may include a fan housing, with a dispersion fan mounted within the fan housing and an exit opening defined in the fan housing, wherein the cut grass clippings are directed through the fan housing and out the exit opening. The dispersion assembly may include a grass kicker and one or more dove tails to redirect mulched grass into the fan tips prior to exiting the exit opening.

The present invention also includes a method for mulching grass clippings comprising the steps of: (a) providing a cutting assembly for attaching to a lawnmower having a mower deck containing at least one mower blade, the mower blade operable to rotate to thereby cut grass into grass clippings, the cutting assembly including a cutting blade separate from the mower blade; directing the grass clippings from the mower blade directly to the cutting assembly; (b) cutting the grass clippings in the cutting assembly with the cutting blade; and (c) dispersing the cut grass clippings onto the ground surface via the dispersion fan.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a front perspective view of a mulching apparatus mounted to a lawnmower according to one embodiment of the present invention.

FIG. 2 is a rear perspective view of a dispersion assembly portion of the present invention.

FIG. 3 is a front perspective view of a forward portion thereof.

FIG. 4 is a close up view of a deck mount portion thereof.

FIG. 5 is a close up view of a deck mount plate according to one embodiment.

FIG. 6 is a close up view of a mulch mount plate according to one embodiment.

FIG. 7 is a close up view of the interior compartment.

FIG. 8 is another close up view of the interior compartment.

FIG. 9 is a close up view of the flow control.

FIG. 10 is a close up view of the stationary feeder.

FIG. 11 is a close up view of the mulching exit opening.

FIG. 12 is another close up view of the mulching exit opening.

FIG. 13 is a close up view of the mulching exit opening with portions of the cutting assembly removed.

FIG. 14 is an exploded view of components of the cutting system.

FIG. 15 is a top view of components of the cutting system.

FIG. 16 is a close up view of the cutting chamber.

FIG. 17 is a top view of an auger according to one embodiment.

FIG. 18 is another view the auger.

FIG. 19 is a close up view of a dispersion assembly inlet according to one embodiment.

FIG. 20 is a close up view of the fan housing according to one embodiment.

FIG. 21 is another close up view of the fan housing.

FIG. 22 is a close up view of the exit opening and grass kicker.

### DESCRIPTION OF THE CURRENT EMBODIMENT

### I. Overview

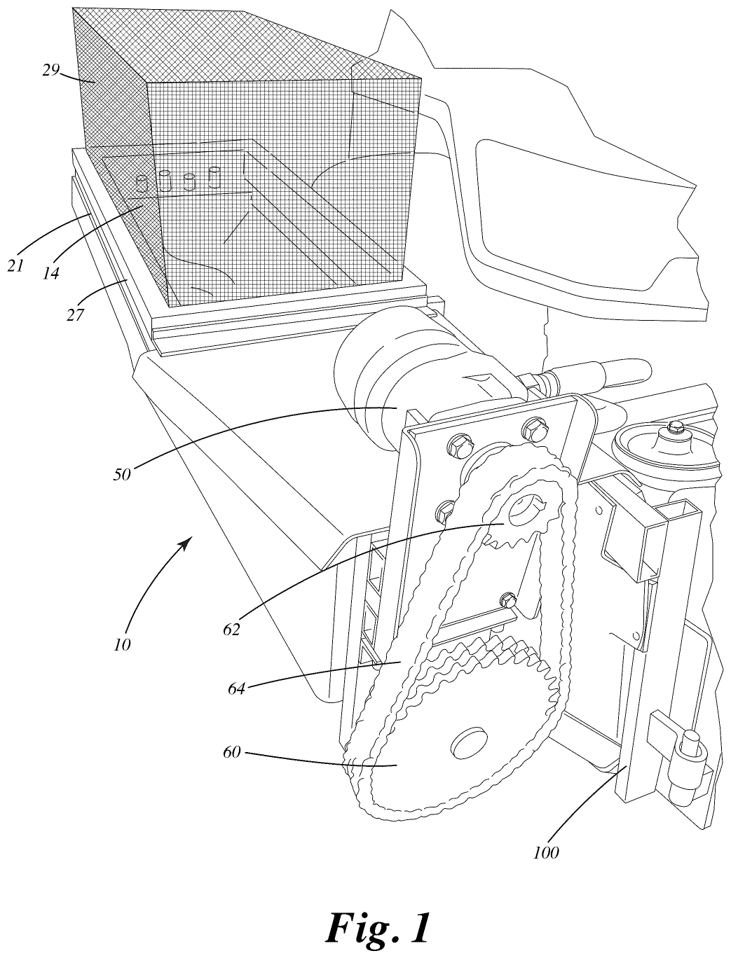

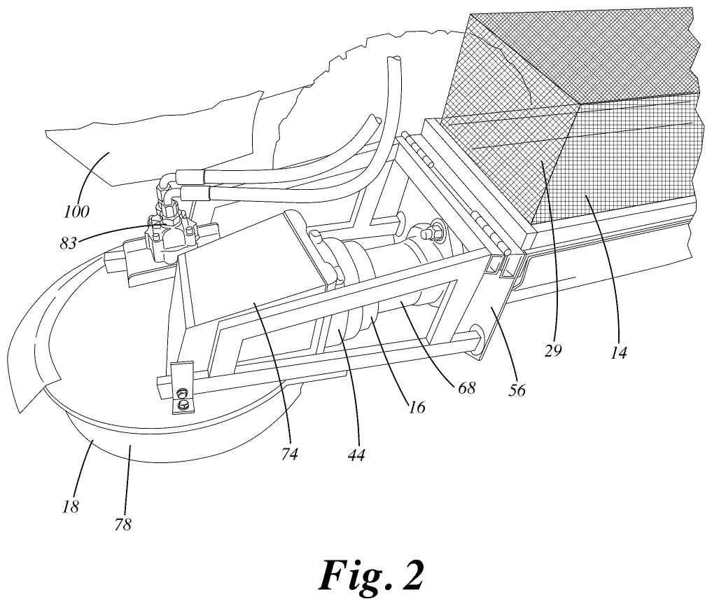

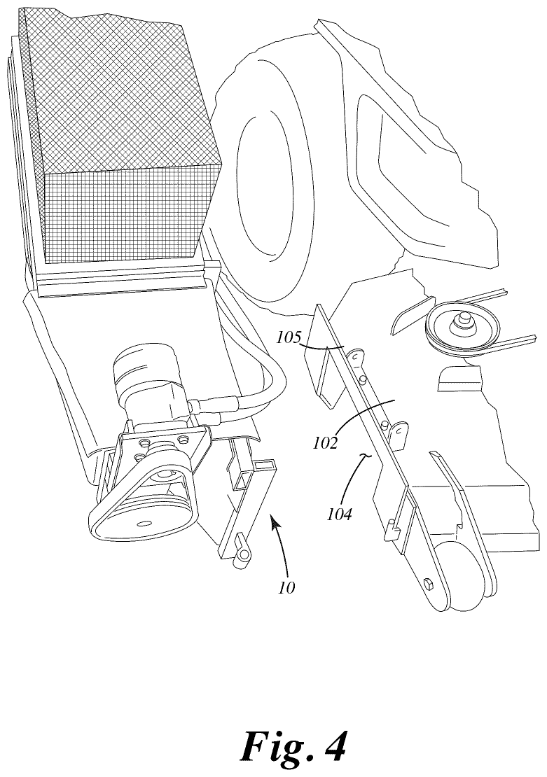

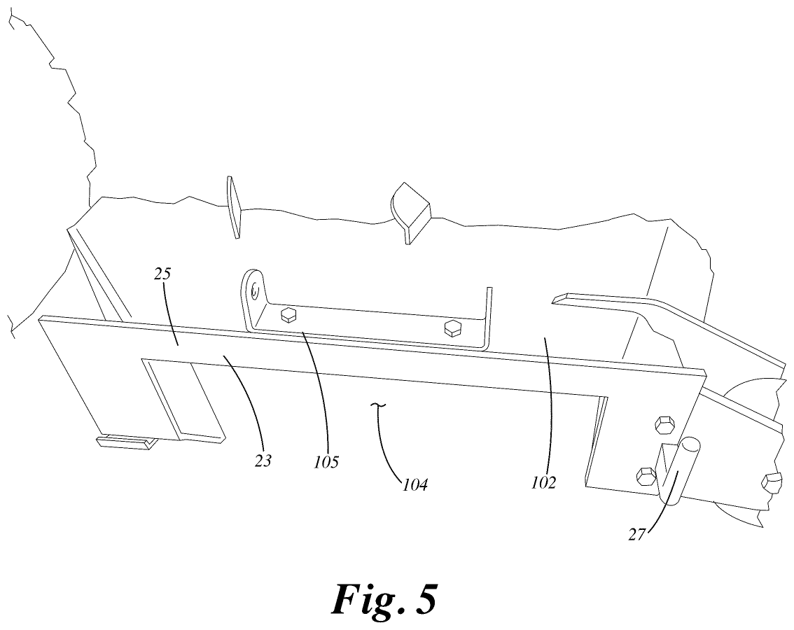

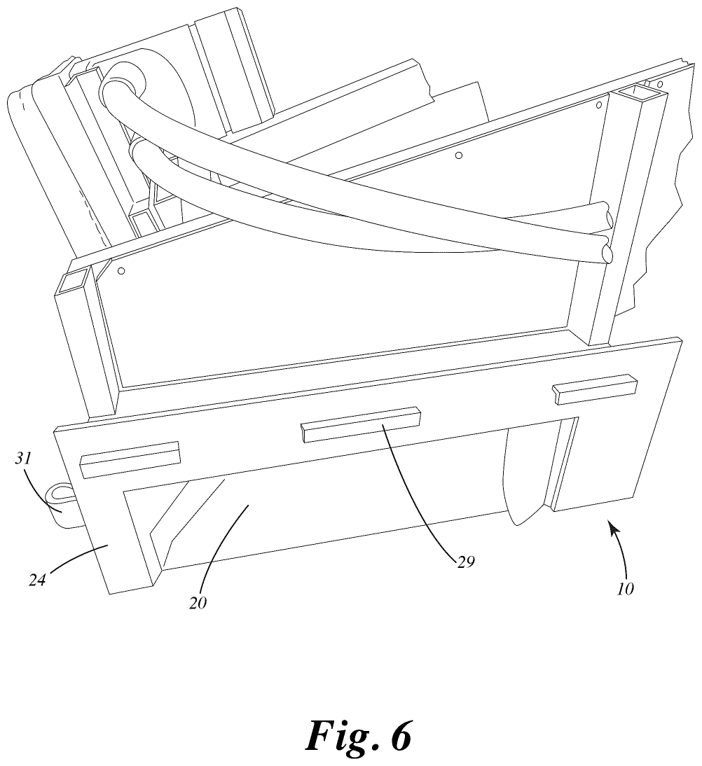

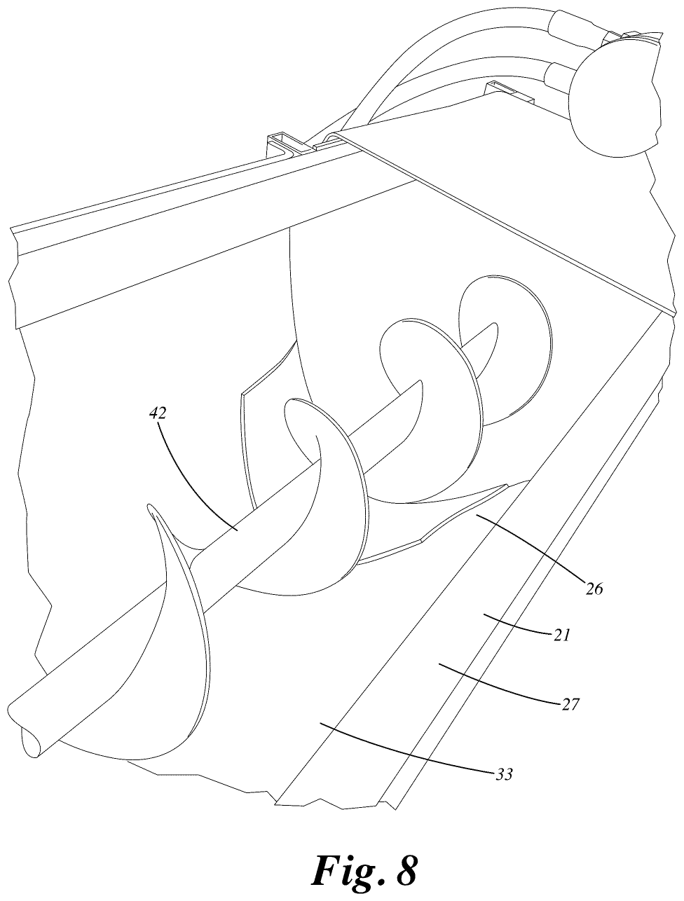

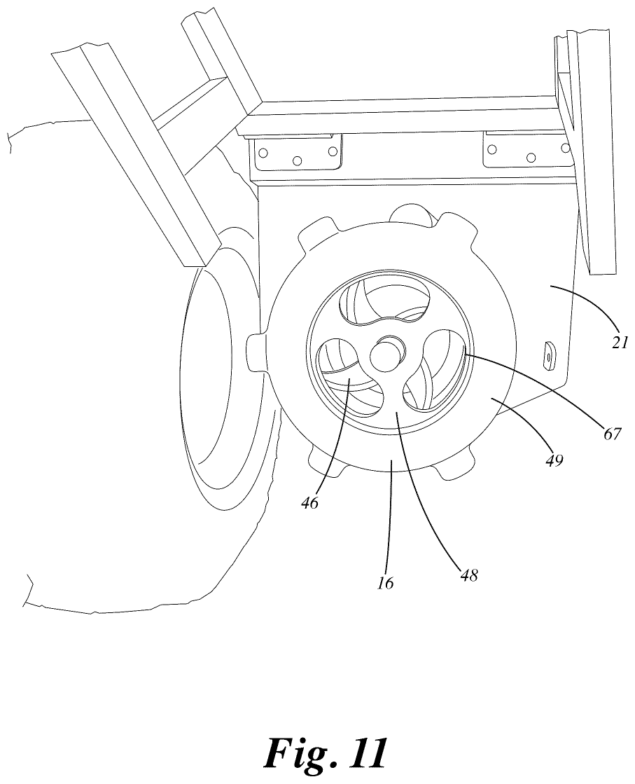

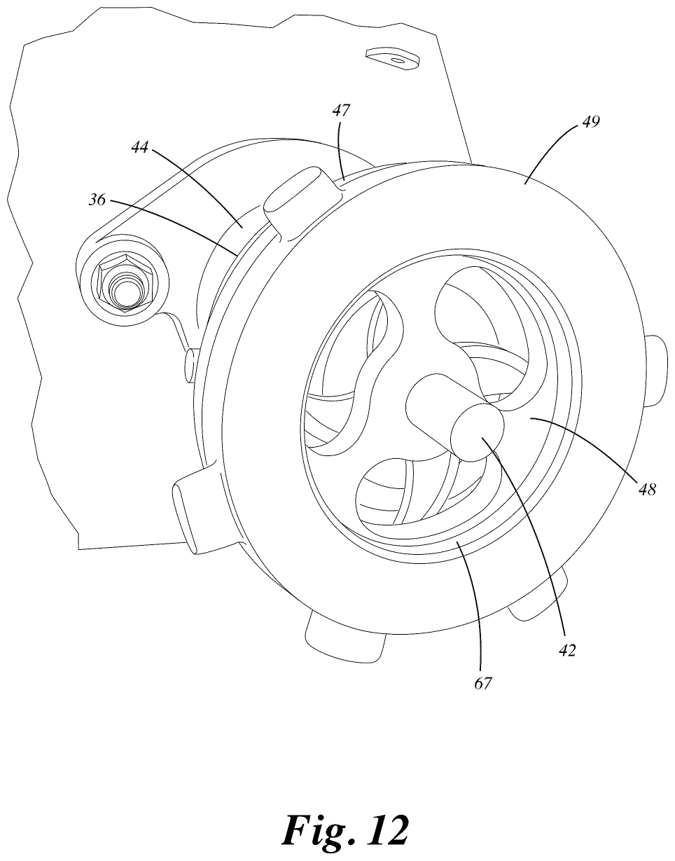

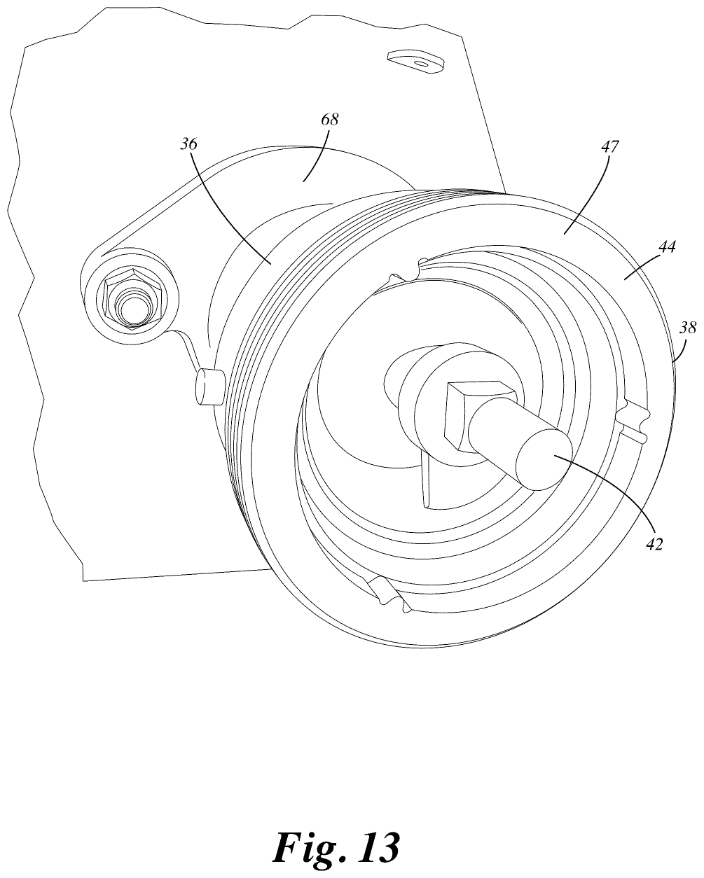

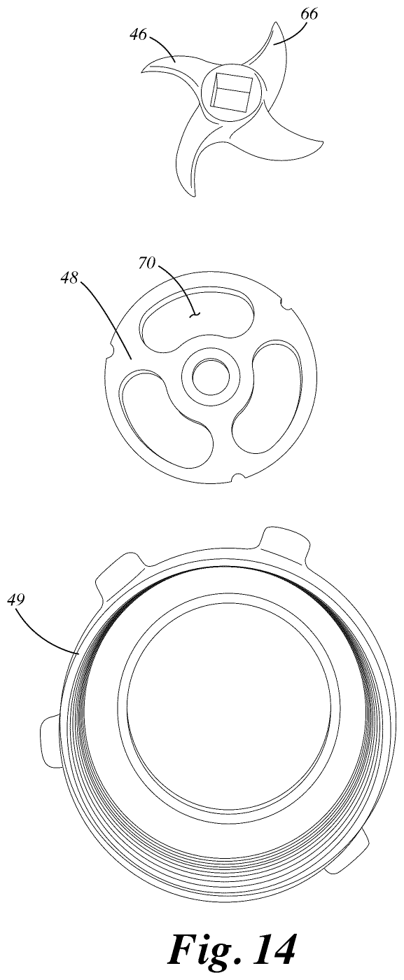

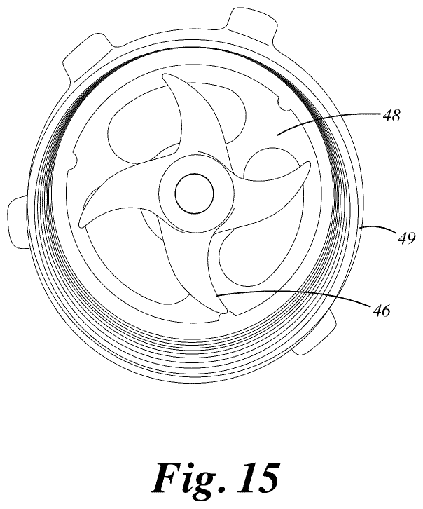

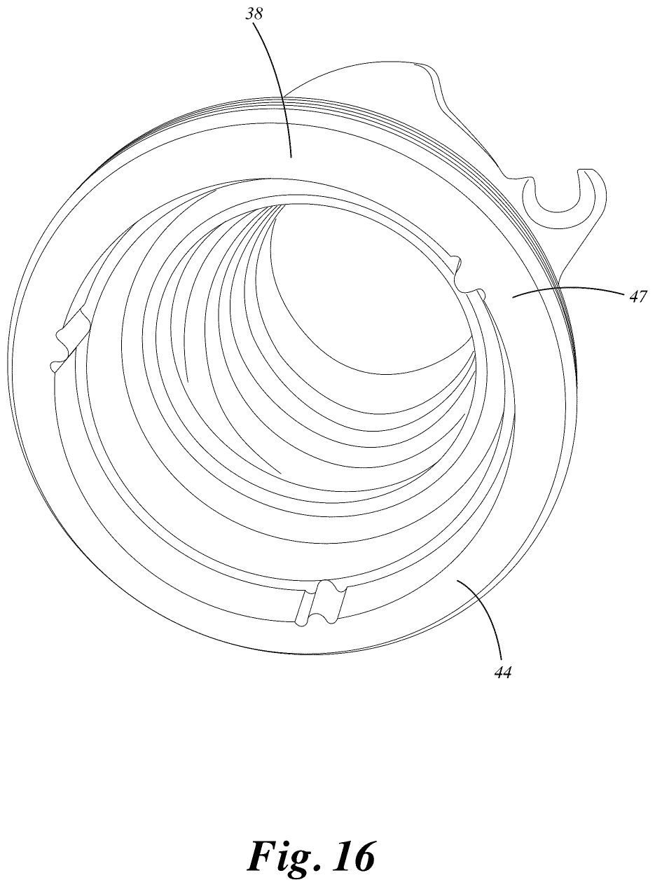

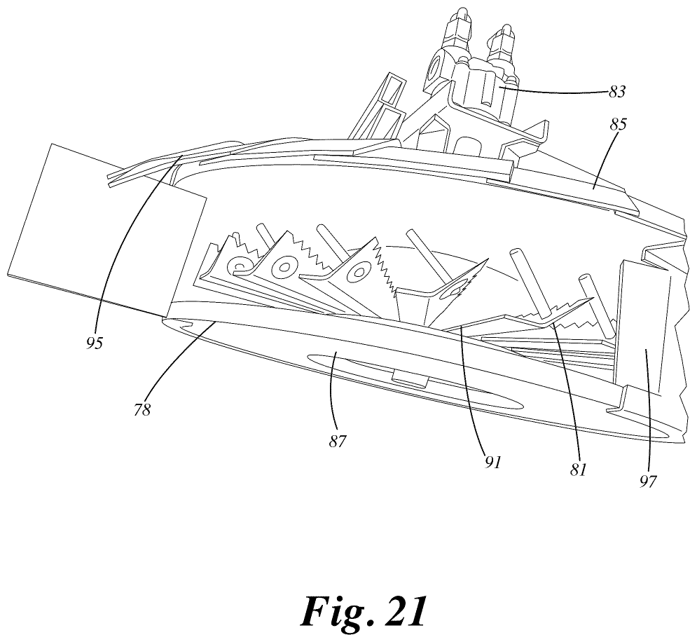

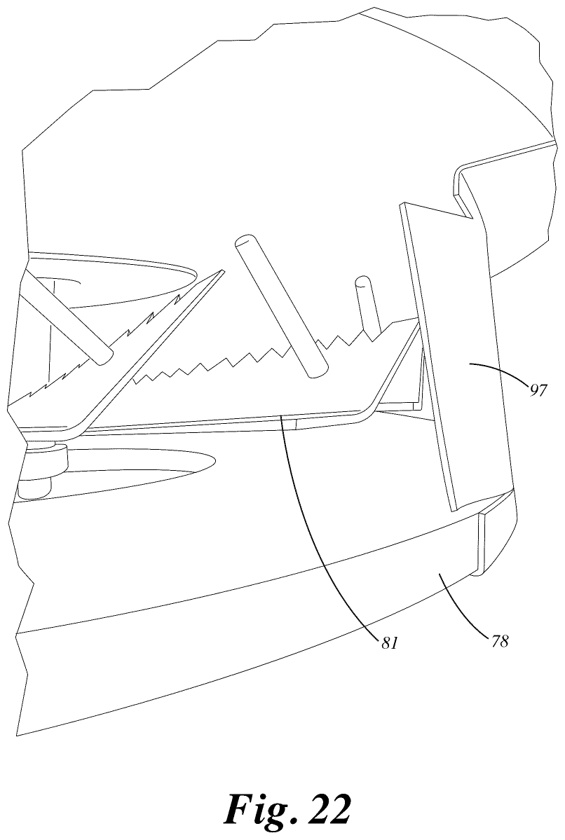

A mulching apparatus for a lawnmower according to one embodiment of the present invention is shown in FIGS. 1-22 and generally designated 10. In the illustrated embodiment, the mulching apparatus 10 is attached to a lawnmower 100, such that grass clippings, leaves, thatch and other yard waste exiting the lawnmower 100 are directed into the mulching apparatus 10, cut into smaller pieces, and then outputted onto the ground surface. The mulching apparatus 10 generally includes a deck mount 12, a separation chamber 14, a cutting assembly 16 and a dispersion assembly 18.

The deck mount 12 may directly attach the mulching apparatus 10 to the blade deck 102 of the lawnmower 100 such that grass clippings exiting the blade deck 102 of the lawnmower 100 are routed into the separation chamber 14, wherein the clippings are further routed into the cutting assembly 16 and then re-cut in a cutting operation separate from the lawnmower blade cutting operation. The re-cut grass clippings exit the cutting assembly 16 and are dispersed onto the ground surface via a dispersion assembly 18. Throughout this description, directional terms, such as “vertical,” “horizontal,” “top,” “bottom,” “upper,” “lower,” “inner,” “inwardly,” “outer” and “outwardly,” may be used to assist in describing the invention based on the orientation of the embodiments shown in the illustrations. The use of directional terms should not be interpreted to limit the invention to any specific orientation(s).

### II. Structure

A mulching apparatus according to the present invention may be designed to attach to a variety of types of conventional lawnmowers including, but not limited to, commercial lawnmowers, residential riding lawnmowers and lawn tractors, and walk-behind lawnmowers. In the illustrated embodiment, the mulching apparatus 10 is shown in connection with a conventional commercial riding lawnmower 100. Because it is conventional, the lawnmower will not be described in detail. Suffice it to say that in general, lawnmowers include a mower deck 102 mounted to the lawnmower 100. The mower deck 102 houses one or more rotating blades that can be actuated to cut grass as the lawnmower moves over the ground surface. The cut grass is generally referred to in this application as “grass clippings.” Many lawnmowers include a port 104 on the mower deck—shown herein as an opening on the side of the mower deck—that can be opened to allow the grass clippings to exit the mower deck 102. In one embodiment, the forced air created by the rotating blade(s) forms a forced air system that acts to force the grass clippings from the mower deck 102 through the port 104. Although the size, shape and structure of various types of lawnmowers may be different, each lawnmower generally includes a structural location where a mulching apparatus such as the current invention can be mounted or attached. It should be appreciated that the size, shape and arrangement of the mulching apparatus components may be altered to accommodate the size, shape and power of the particular type of lawnmower to which it is attached. For example, the components of a mulching assembly 10 for attachment to residential riding lawnmower or walk-behind lawnmower—although consistent in structure and function to those of the illustrated embodiment—may be smaller and more compact than those shown in the illustrated embodiment in connection with a commercial lawnmower 100.

The deck mount 12 forms a structure for mounting the mulching apparatus 10 to the lawnmower 100 in a manner that aligns an intake port 20 on the mulching apparatus 10 with the port 104 of the mower deck 102. In one embodiment, the deck mount 12 includes a deck mount plate 23 on the mower deck 102 and a mulch mount plate 24 on the mulching apparatus 10. The deck mount plate 23 may be formed integrally with the mower deck 102, or may be separately attached to the mower deck 102 specifically for retrofit attachment of a mulching apparatus 10. The deck mount plate 23 and mulch mount plate 24 each include structure configured to attach the mulch mount plate 24 to the deck mount plate 23. In the illustrated embodiment, the deck mount plate 23 extends around at least a portion of the port 104 and the mulch mount plate 24 extends around at least a portion of the intake 20 to enable alignment of the port 104 and the intake 20 when the mulch mount plate 24 is mounted on the deck mount plate 23. In the illustrated embodiment, the mounting structure includes a top mounting edge 25 and an upwardly extending pin 27 on the deck mount plate 23, and a series of downwardly extending flanges 29 and an upright sleeve 31 on the mulch mount plate 24. In order to mount the mulch mount plate 24 on the deck mount plate 23, the flanges 29 are hooked over the top edge 25 of the deck mounting plate 23 and the pin 27 is inserted into the sleeve 31 forming a rigid mounting connection between the plates 23, 24 and with the mulching apparatus 10 extending adjacent to and generally parallel with a side edge 105 of the lawnmower 100. Alternative mounting arrangements may otherwise be utilized for mounting the mulching apparatus 10 to the lawnmower, including the use of a chute extending between the mower deck 102 and the mulching apparatus 10.

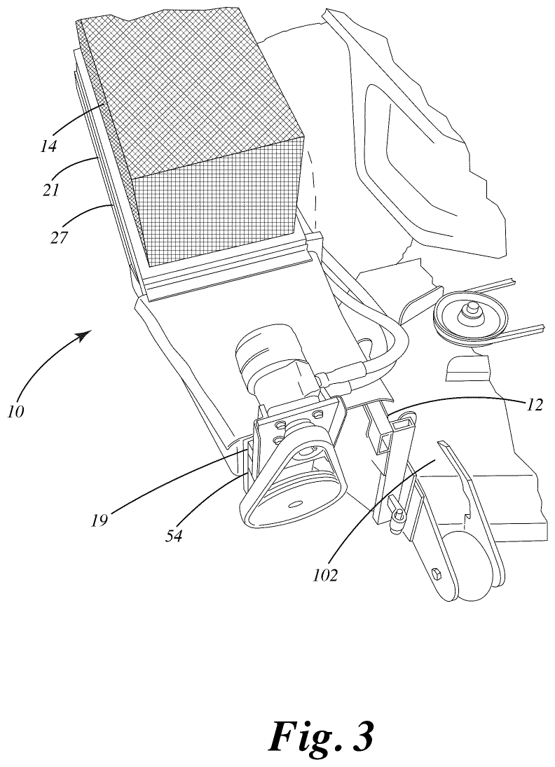

The separation chamber 14 provides a space and system for separating the cut grass clippings from the forced air exiting the mower deck 102. In the illustrated embodiment, this is done by venting the forced air from the mulching apparatus 10. As shown, the mulching assembly 10 includes a housing 21 defining an interior compartment 26 having a rear wall 17, a front wall 19 opposite the rear wall 17, and a pair of sidewalls 33 that slope inwardly. The intake port 20 of the mulching apparatus 10 defines an opening in the housing 21 for intake of the combined cut grass clippings and forced air into the housing 21. The separation chamber 14 forms a portion of the interior compartment 26, and in one embodiment, an upper portion of the interior compartment 24. In this embodiment, the interior compartment 26 may also house other components of the apparatus 10, as discussed in more detail below. With reference to FIGS. 1 and 3, for example, the housing 21 defines an upper end 27 that forms an opening to the interior compartment 26. The upper end 27 may be closed with a venting material that enables the forced air to exit the separation chamber 14 to the atmosphere while retaining the cut grass clippings. In one embodiment, the material is a wire mesh material 29 forming a box shape over the opening at the upper end 27. The wire mesh material 20 may be one of a variety of gauges, and may have a variety of shapes.

The cutting assembly 16 provides a system for re-cutting the grass clippings in an operation separate from the initial cut within the mower deck 102. In one embodiment, the cutting assembly 16 is designed to cut the grass clippings by compressing the clippings into a compression cutting chamber 44 and forcing them through at least one cutting blade. In the illustrated embodiment, the cutting assembly 16—or at least a portion thereof—is positioned within the interior compartment 26 of the housing 21, below the separation chamber 14 portion of the compartment 26. In this way, the combined cut grass clippings and forced air enter the housing 21 through the intake port 20, with the forced air exiting upwardly through the separation chamber 14 and the cut grass clippings falling into the cutting assembly 16.

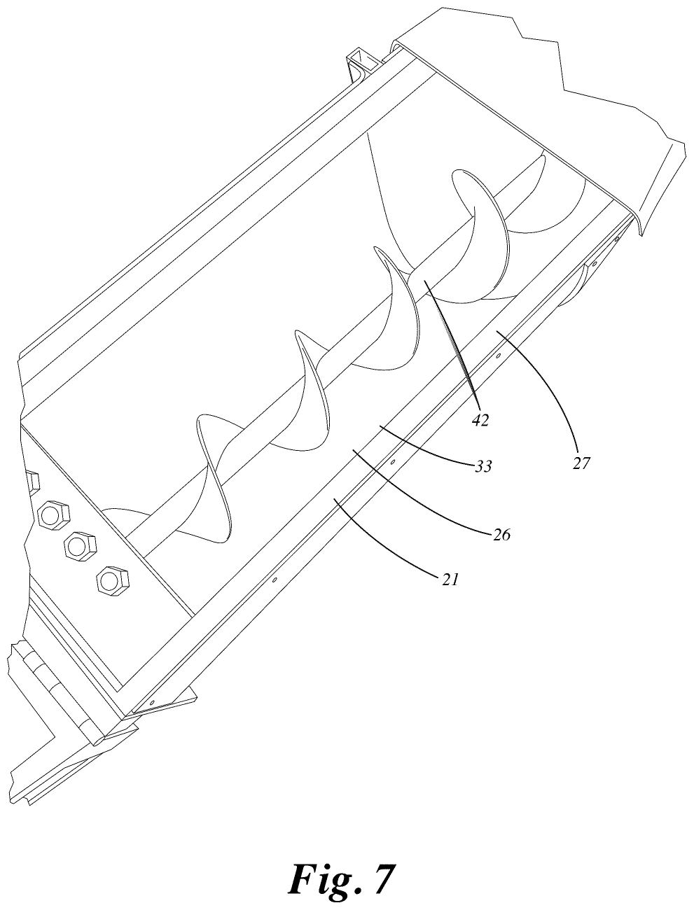

The cutting assembly 16 generally includes an auger 42, a cutting chamber 44, a blade 46, an adapter 47, a stationary plate 48 and a cap 49. With reference to FIGS. 7-10, the auger 42 extends along a bottom portion of the interior compartment 26, wherein the interior compartment 26 may include opposing sloped walls 33 that act to funnel the cut grass clippings to the auger 42. The auger 42 may be driven to rotate about a central axis. In one embodiment, the auger 42 includes a first end 52 supported by a first support plate 54 at the front wall 19 of the housing 21, and a second end 55 extending through a second support plate 56 at the rear wall 17 of the housing 21. As shown, the first end 52 of the auger 42 includes a drive shaft 58. A drive gear 60 is mounted on the drive shaft 58 such that the drive gear 60 rotates with the drive shaft 58 about the central axis. In the illustrated embodiment, the drive gear 60 is connected to a motor gear 62 with a drive belt or chain 64. The motor gear 62 is connected to an auger drive motor 50, which may be a hydraulic motor mounted onto the mulching apparatus 10 or the lawnmower 100 in a conventional manner. Operation of the auger drive motor 50 causes the auger 42 to rotate about the central axis. The auger 42 may be driven by a variety of conventional methods, and at a variety of speeds depending on the desired volume of grass to be transported to the cutting chamber 44. In one embodiment, the auger 42 is driven at about 75 rpm. Although the mulching apparatus 10 includes a secondary motor 50 powered separately from the lawnmower 100, it is quite possible that in other embodiments the auger 42 may be driven directly by the primary motor of the lawnmower 100, for instance, by an auxiliary drive shaft extending from the primary motor.

The second end 55 of the auger extends into the cutting chamber 44, which in the illustrated embodiment is formed by a cylindrical pipe 68 mounted to the second support plate 56 and an adapter 47 attached to the cylindrical pipe 68. The cylindrical pipe 68 may have a first diameter, such as 4 inches, and the adapter 47 may have a second diameter that is greater than the first diameter, such as 5 or 6 inches. The adapter 47 may attach to the pipe 68 in a conventional manner, and acts to reduce the pressure on the cut grass within the cutting chamber 44 as the cut grass passes to the blade 46. In the illustrated embodiment, the adapter 47 is a cylindrical pipe having a first end 36 attached to the pipe 68 and a second end 38 that is partially closed with the cap 49 to form a mulching exit opening 67. The blade 46 may be mounted on the second end 55 of the auger 42 within the adapter 47 of the cutting chamber 44 such that the blade 46 rotates with the auger 42. Although the blade 46 may be located in the pipe 68 portion or the adapter 47 portion of the cutting chamber 44, placement within the adapter 47 enables the use of a larger diameter blade 46, which may increase the capacity of the cutting assembly 16 and the system 10 as a whole. In the illustrated embodiment, the blade 46 includes four spaced apart knife blades 66 extending outwardly from the central axis, although a variety of blade arrangements may be used. In addition, the stationary plate 48 is mounted on the second end 55 of the auger 42 within adapter 47. As shown, the stationary plate 48 includes a series of spaced apart holes 70 extending through the stationary plate 48. The shape, size and spacing of the holes 70 may be configured to maximize the flow rate of the re-cut/mulched grass clippings through the stationary plate 48. In the illustrated embodiment, the plate 48 defines three elongated holes of equal size spaced evenly apart about the plate 48. Alternatively, the holes 70 may vary in size and may have an oval, triangular, rectangular, square, or other desired shape. The stationary plate 48 may be mounted such that it remains stationary with respect to the blade 46 and auger 42.

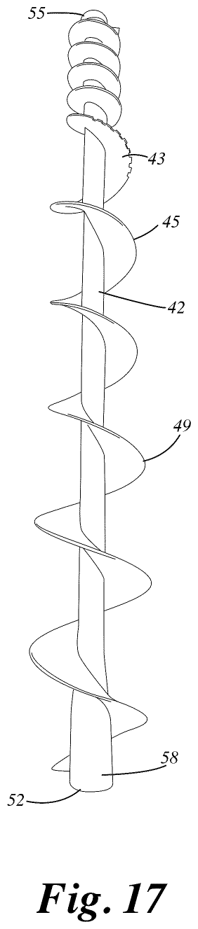

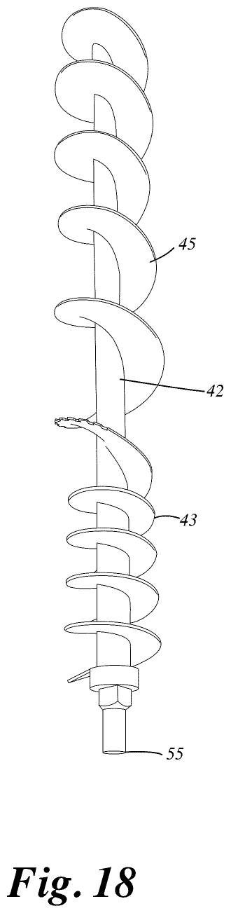

FIGS. 17 and 18 show an embodiment of the auger 42 removed from the mulching apparatus 10 for purposes of description. In this embodiment, the pitch and the diameter of the flighting 43 of the auger 42 is designed for use in a mulching apparatus 10, wherein the auger design aides in controlling the movement of the cut grass clippings to the compression chamber 44. In one embodiment, at least one of the pitch (i.e., distance between sequential twists 45) of the flighting 43 and the outer diameter of the flighting 43 varies along the length of the auger 42 between the first end 52 and the second end 55. As illustrated, the pitch of the auger 42 reduces as it approaches the second end 55 adjacent the cutting chamber 44. This may assist in slightly compressing the cut grass clippings as the clippings travel to the cutting chamber 44. As further illustrated, the outer diameter of the flighting 43 decreases approaching the cutting chamber 44. In one embodiment, twists 45 closest to the first end 52 may have an outer diameter of about 6″, the twists 45 within a central section may have an outer diameter of about 5″, and the twists 45 within a third section nearer the second end 55 may have an outer diameter of about 4″, and the twists within a final section nearest to the second end 55 may have an outer diameter of about 3″. In one embodiment, the outer edge 49 of the flighting 43 may be provided with a toothed or undulated surface to assist in agitating the cut grass clippings and encouraging them toward the cutting chamber 44.

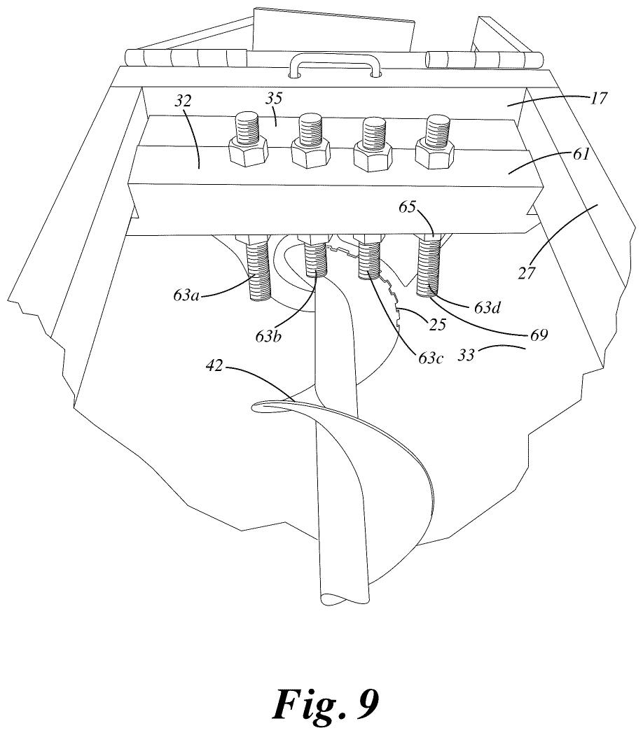

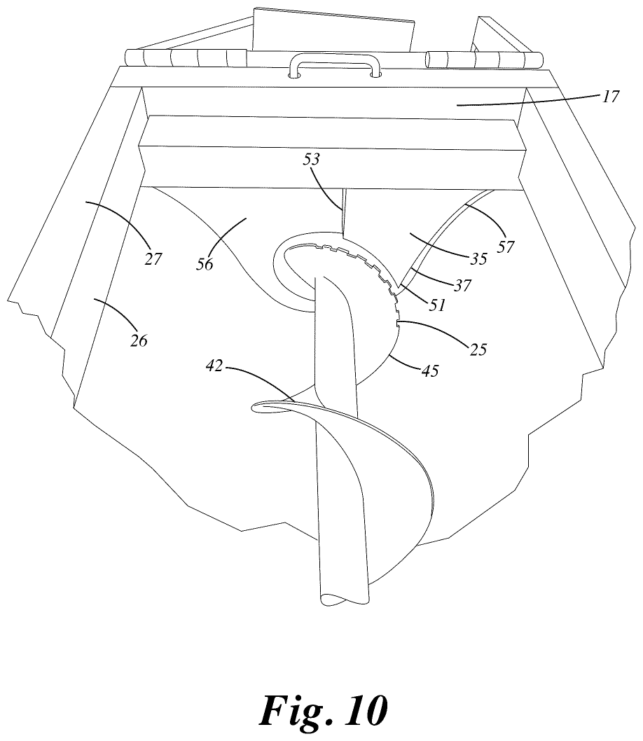

With reference to FIGS. 9 and 10, the mulching apparatus 10 may additionally include a flow control 32 and a stationary feeder 35. In one embodiment, the stationary feeder 35 is a wall section positioned adjacent to the rear wall 17 of the housing 21. The stationary feeder 35 includes a bottom edge 37 that is shaped to prevent the cut grass clippings grass from clumping between the flighting 43 of the auger 42 and the rear wall 17 of the housing 21 as the cut grass clippings are moved toward the cutting chamber 44 by the rotation of the flighting 43. In the illustrated embodiment, the bottom edge 37 is arc shaped to generally match the shape of the outer diameter of the twist 45 nearest to the rear wall 17 within the internal compartment 26. The stationary feeder 35 includes an interior wall 53 and an exterior wall 57, with the bottom edge 37 extending between the interior wall 53 and the exterior wall 57. The bottom edge 37 extends to a point 51 where it meets the exterior wall 57, and the point 51 is positioned between the twist 45 and the sidewall 33 toward which the auger 42 rotates. The spacing between the bottom edge 37 and the twist 45 may be adjusted as desired to prevent the cut grass clippings from clumping within the interior compartment in the area of the point 51. In the illustrated embodiment, the stationary feeder 35 is a block of wood material that is attached to the rear wall 17 of the housing 21 and extends from the upper edge 27 of the housing 21 downwardly along a sidewall 33 to the bottom edge 37. In another embodiment, the stationary feeder 35 may be formed from a different material, such as steel, aluminum, or a polymer, and may be attached to or supported by a different portion of the mulching apparatus 10 while maintaining a desired shape and positioning of the bottom edge 37 with respect to the auger 42.

With reference to FIG. 9, in one embodiment, the flow control 32 is positioned adjacent to and in front of the stationary feeder 35 within the interior compartment 26. The flow control 32 may be designed to regulate the amount of cut grass clippings that reach the stationary feeder 35 and rear wall 17 and further prevents the cut grass clippings from being wedged and clumping between the auger 42 and the sidewalls 33. In one embodiment, the flow control 32 includes a base 61 attached adjacent to the upper edge 27 of the housing 21, and multiple spaced apart regulator bars 63 extending downwardly in front of the stationary feeder 35 and generally such that the final twist 45 of the auger 42 is positioned between the regulator bars 63 and the stationary feeder 35. In one embodiment, the regulator bars 63 are cylindrical rods having a first end 65 at the base 61 and a distal end 69 opposite the first end 65, wherein each of the regulator bars 63 define a length between the first end 65 and the distal end 69. In one embodiment, the respective lengths of the regulator bars 63 may vary to accommodate the auger 42 and provide a desired degree of cut grass clipping flow control. As shown, the flow control 32 includes four regulator bars 63a-63d that are evenly spaced apart, the two outer bars 63a and 63d having a longer length than the two inner bars 63b and 63c. The lengths of the regulator bars 63, and the spacing between regulator bars 63 may be varied to properly regulate the flow of cut grass clippings to the cutting chamber 44, and may depend on a variety of factors such as the speed of auger rotation, the spacing and size of the auger flighting 43, the capacity of the cutting chamber 44. The flow control base 61 and the regulator bars 63 may be made from a variety of materials and attached to the mulching apparatus 10 in a variety of ways. In one embodiment, the flow control 32 may be formed integrally with the stationary feeder 35.

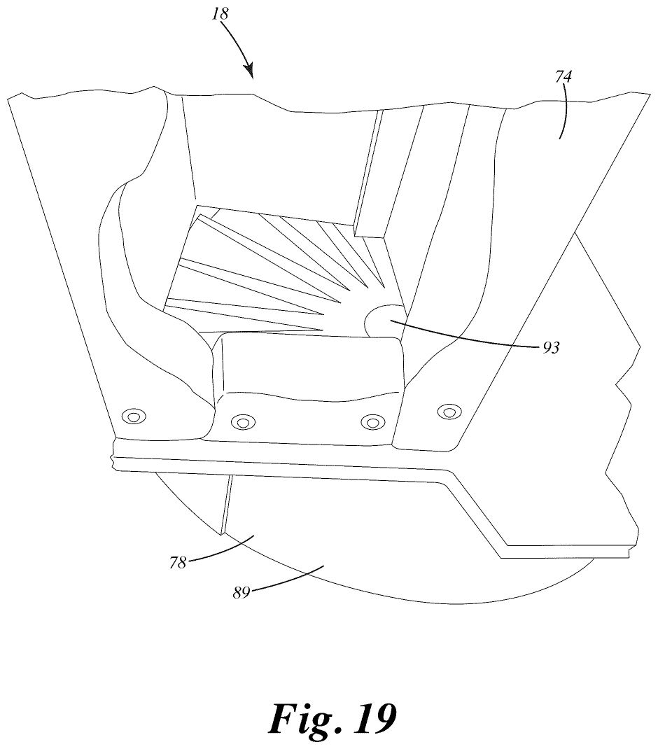

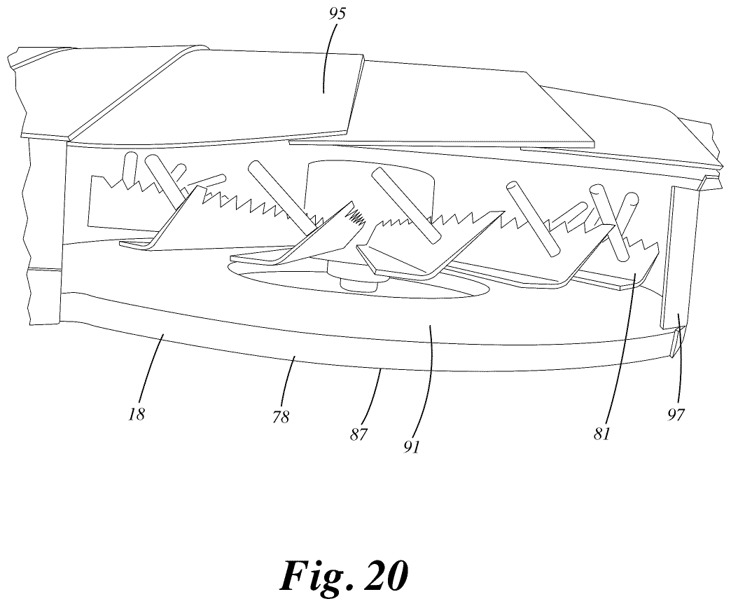

The dispersion assembly 18 operates to spread the re-cut grass clippings as a mulch onto the ground surface. In one embodiment, the dispersion assembly 18 includes an inlet housing 74 and a fan housing 78 attached to and in communication with the inlet housing 74. The inlet housing 74 attaches over the mulching exit opening 67 and provides a pathway for the mulched grass after exiting the cutting chamber 44 and prior to entering the fan housing 78. The fan housing 78 may attached to and be positioned below the inlet housing 74. In one embodiment, a dispersion fan 81 is positioned within the fan housing 78 and connected to a fan motor 83 mounted to the mulching apparatus 10 and capable of driving the dispersion fan 81 to rotate within the fan housing 78. In one embodiment, the fan housing 78 includes an upper wall 85, a bottom wall 87 spaced from the upper wall 85, and a sidewall 89 extending between the upper wall 85 and the bottom wall 87. With reference to FIGS. 20-22, the sidewall 89 defines an exit opening 91 for exit of the mulched grass clippings from the mulching apparatus 10 to the ground. With reference to FIG. 19, the inlet housing 74 may be positioned above an inlet 93 in upper wall 85 of the fan housing 78 such that mulched grass entering the inlet housing 74 will fall into the fan housing 78 through the inlet 93, and then be blown out of the exit opening 91 by the rotating dispersion fan 81. Notably, the direction of dispersion of the exiting mulched grass can be controlled by the positioning of the exit opening 91 on the fan housing 78.

In one embodiment, the fan housing 78 may include one or more structural features for interacting with the mulched grass passing through the fan housing 78 to encourage the mulched grass to spread evenly onto the ground. With reference to FIG. 20, in one embodiment, this structure includes a series of dove tails 95 wherein overlapping portions of the upper wall 85 of the fan housing 78 are angled downwardly at their peripheral edges in the area of the exit opening 91 to extend into the boundary of the exit opening 91. In this way, as the mulched grass is blown out of the exit opening 91, any portion of the mulched grass that exits near the upper wall 85 will be broken apart by the dove tails 95 to avoid clumping of the mulched grass and promote even dispersion of the exiting mulched grass. In another embodiment, the fan housing 78 also includes a grass kicker 97 on the sidewall 89 of the fan housing 78 at the exit opening 91. More particularly, as shown in FIGS. 20-22, the grass kicker 97 is formed from an inwardly bent section of the sidewall 89 at the forward edge of the exit opening 91 (i.e., the first edge of the exit opening 91 passed by each fan blade). The grass kicker 97 extends towards the blade tips 99 to reduce the gap between the sidewall 89 and the blade tips 99 and therefore direct a portion of the mulched grass that has migrated toward the sidewall 89 back toward the blade tips 99 to be dispersed out of the exit opening 91 by the dispersion fan 81. The size and angles of the dove tails 95 and/or grass kicker 97 may be adjusted as desired, in order to maximize the dispersion of mulched grass exiting the exit opening 91. This may depend on multiple factors, such as the conditions of the grass prior to cutting, the speed of the auger, and the speed of the dispersion fan.

### III. Operation

Operation of the mulching apparatus 10 generally includes the steps of: (a) attaching the mulching device 10 to a lawnmower deck 102, (b) expelling grass clippings from the lawnmower deck 102, (c) separating the grass clippings from the forced air created by the mower blades, (c) cutting the grass clippings with a blade separate from the mower blades, and (d) dispersing the re-cut grass (i.e., mulch) onto the ground surface via the dispersion fan.

In a more particular embodiment, the step of attaching the mulching apparatus 10 to the mower deck 102 may include a deck mount 12, which includes a deck mount plate 23 on the mower deck 102 with a mulch mount plate 24 on the mulching apparatus 10 in a manner that aligns the port 104 and the intake 20 of the mulching apparatus 10. The step of expelling the grass clippings may include forcing the grass clippings through the intake 20 and into the separation chamber. The step of separating the grass clippings from the forced air may be accomplished by a variety of methods, including blowing the grass clippings into the housing 21 and letting the clippings fall into the cutting assembly 16 while the forced air is expelled through I the wire mesh material 29. The converging sidewalls 33 at the bottom of the interior compartment 26 act to funnel the falling grass clippings to the auger 42 of the cutting assembly 16.

The cutting assembly 16 operates to re-cut the grass clippings into small pieces such that they form a mulch that can be dispersed and dropped onto the ground surface generally without forming visible clumps or pieces of grass on the ground surface. In one embodiment, the cutting assembly 16 re-cuts or “mulches” the grass clippings in an environment separate from the forced air (for example, as a result of the separation chamber 14). This isolated cutting operation may enable a more controlled and finer cut of the grass clippings. Referring to FIGS. 7-18, the cut grass clippings fall into the rotating auger 42 and the auger forces the grass clippings into the cutting chamber 44. More particularly, the pitch of the auger twists 45 near the cutting chamber 44 are spaced closer to one another, such that the grass clippings become compressed between the auger twists 45 as the move toward the cutting chamber 44. And additionally, the outer diameter of the auger twists 45 may decrease approaching the cutting chamber 44.

As the compressed grass clippings are transported along the auger 42 toward the cutting chamber 44, they pass through the flow control 32 and the stationary feeder 35. The regulator bars 63 of the flow control 32 act to control the amount of grass clippings above the auger 42 that can pass through to the stationary feeder 35 and the cutting chamber 44 to prevent clumping and stagnation of the grass clippings in the interior compartment 26 near the cutting chamber 44. In addition, the bottom edge 37 of the stationary feeder 35 prevents gathering and clumping of the cut grass in the area between the auger 42 and the sidewall 33. After passing through the flow control 32 and beyond the stationary feeder 35, the cut grass clippings are then forced into the cutting chamber 44 and pass through the blades 66 of the knife 46 and the plate 48 and cut into fine pieces that pass through the holes 70 in the plate 48. In one embodiment, the clippings are mulched into pieces that are between about 0.125″ and 0.3125″ long.

Finally, the mulch or “mulched clippings” are dispersed onto the ground surface via the dispersion assembly 18. In one embodiment, the mulched clippings are dispersed in such a way that there are no visible clumps or piles of mulched clippings on the ground surface. In the illustrated embodiment, the inlet housing 74 of the dispersion assembly 18 attaches over the mulching exit opening 67 such that the mulched grass (i.e, grass that has been initially cut by the lawnmower 100 and then re-cut by the cutting assembly 16) falls into the inlet housing 74 and then into the fan housing 78 and into the rotating blades of the dispersion fan 81 to be blown out the exit opening 91 in the sidewall 89 of the fan housing 78. The dove tails 95 and the grass kicker 97 assist in redirecting the mulched grass into the blade tips 99 to provide a more even dispersion pattern as the mulched grass exits the exit opening 91.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A mulching device for attachment to a lawnmower having a mower deck and at least one lawnmower blade within the mower deck, the mulching device comprising:
a mulch plate bracket adapted to be attached to a mower deck for receiving grass clippings from the lawnmower;
a cutting assembly connected to the mulch plate bracket, the cutting assembly including a cutting chamber having an inlet at a first end for receiving grass clippings and an outlet at a second end, the cutting assembly including at least one cutting blade configured to cut the grass clippings into mulched grass clippings; and
a dispersion assembly for dispersing the mulched grass clippings onto a ground surface, the dispersion assembly including a dispersion fan positioned within a fan housing, the fan housing defining an exit opening, the mulched grass clippings received in the fan housing and forcefully directed through the exit opening by the dispersion fan.

2. The mulching device of claim 1 wherein the mower deck includes a deck mount bracket on the mower deck, the mulch plate bracket designed to attach to the deck mount bracket to enable the mulching device to directly receive the cut grass clippings from the mower deck.

3. The mulching device of claim 1 wherein the cutting assembly includes an auger that extends into the cutting chamber, the auger flighting having a pitch and an outer diameter, the pitch decreasing approaching the cutting chamber, the outer diameter decreasing approaching the cutting chamber.

4. The mulching device of claim 1 wherein cutting assembly includes an auger that extends into the cutting chamber, the auger rotating about an auger axis, and wherein the lawnmower blade rotates about a blade axis disposed at an angle with respect to the auger axis.

5. The mulching device of claim 1 wherein the fan housing includes a grass kicker adjacent the exit opening.

6. The mulching device of claim 1 wherein the fan housing includes a plurality of dove tails adjacent the exit opening.

7. The mulching device of claim 1 including a separation chamber separating the grass clippings from the forced air, the separation chamber including a housing having a pair of converging sidewalls and an upper end, the upper end covered with a wire mesh material to enable escape of the forced air.

8. A mulching device for attachment to a lawnmower having a mower deck and at least one lawnmower blade within the mower deck, the lawnmower blade rotating about a blade axis and having a peripheral edge, and the mower deck defining an exit opening at a side of the mower deck adjacent to the rotating peripheral edge of the blade, the mulching device comprising:
a mulch housing positioned adjacent to the mower deck, the mulch housing defining an intake port and a mulch chamber, the intake port aligned with the exit opening of the mower deck to receive mulched grass clippings exiting the exit opening of the mower deck through the intake port and into the mulch chamber;
a mulch plate bracket on the mulch housing, the mulch plate bracket adapted to be attached to the mower deck;
a cutting assembly, the cutting assembly including a cutting chamber connected to the mulch housing adjacent to the mulch chamber, the cutting chamber having an inlet at a first end for receiving grass clippings and an outlet at a second end, the cutting assembly including at least one cutting blade configured to cut the grass clippings into mulched grass clippings; and
a dispersion assembly for dispersing the mulched grass clippings onto a ground surface, the dispersion assembly including a dispersion fan positioned within a fan housing, the fan housing defining an exit opening, the mulched grass clippings received in the fan housing and forcefully directed through the exit opening by the dispersion fan.

9. The mulching device of claim 8 wherein the mulch housing defines a forced air vent extending from the mulch chamber to the atmosphere to allow forced air entering the mulch chamber with the grass clippings to separate from the grass clippings and exit the forced air vent.

10. The mulching device of claim 9 wherein the forced air vent includes a section of mesh screen material covering a portion of the mulch chamber.

11. The mulching device of claim 10 wherein the mulch housing includes an upper wall, a lower wall, a sidewall between the upper and lower walls, a front wall and a rear wall, the walls collectively having an interior surface defining the mulch chamber, the cutting chamber inlet defined in the rear wall, the forced air vent defined in the upper wall.

12. The mulching device of claim 11 wherein the lower wall of the mulch chamber includes a pair of converging walls.

13. The mulching device of claim 12 wherein the cutting assembly includes an auger extending from the mulch chamber into the cutting chamber, the auger rotatable about an auger axis to drive the cut grass clippings into the cutting chamber.

14. The mulching device of claim 13 wherein the auger is positioned between and adjacent to the converging lower walls.

15. The mulching device of claim 14 wherein the cutting chamber includes a first portion having a first diameter and a second portion defining a second diameter greater than the first diameter.

16. The mulching device of claim 14 wherein the cutting blade is positioned within the second portion.

17. The mulching device of claim 16 including a flow control positioned within the mulch chamber adjacent the rear wall of the mulch chamber, the flow control including a plurality of spaced apart rods extending downwardly toward the auger.

18. The mulching device of claim 17 including a stationary feeder positioned adjacent to the rear wall of the mulch chamber, the stationary feeder including a wall protecting downwardly toward the auger, the wall having an arc shaped lower edge facing the auger.

19. The mulching device of claim 18 wherein the stationary feeder is positioned between the flow control and the rear wall of the mulch chamber.

20. A mulching device for attachment to a lawnmower having a mower deck and at least one lawnmower blade within the mower deck, the lawnmower blade having a peripheral edge, and the mower deck defining an exit opening at a side of the mower deck, the mulching device comprising:
a mulch housing positioned adjacent to the mower deck, the mulch housing defining an intake port and a mulch chamber, the intake port aligned with the exit opening of the mower deck to receive grass clippings exiting the exit opening of the mower deck through the intake port and into the mulch chamber;
a forced air vent extending from the mulch chamber to the atmosphere to allow forced air entering the mulch chamber with the grass clippings to separate from the grass clippings and exit the forced air vent;
a mulch plate attachment on the mulch housing, the mulch plate attachment adapted to be attached to the mower deck;
a cutting assembly, the cutting assembly including a cutting chamber connected to the mulch housing adjacent to the mulch chamber, the cutting chamber having an inlet at a first end for receiving grass clippings and an outlet at a second end, the cutting assembly including at least one cutting blade configured to cut the grass clippings into mulched grass clippings, the cutting chamber including a first section having a first diameter and a second section having a second diameter greater than the first diameter, the inlet positioned within the first section, the cutting blade positioned in the second section, the cutting assembly including an auger extending from the mulch chamber into the cutting chamber, the auger rotatable to drive the grass clippings into the cutting chamber; and
a dispersion assembly for dispersing the mulched grass clippings onto a ground surface, the dispersion assembly including a dispersion fan positioned within a fan housing, the fan housing defining an exit opening, the mulched grass clippings received from the cutting chamber outlet into the fan housing and forcefully directed through the exit opening by the dispersion fan.
